(19) United States
(12) Patent Application Publication
(10) Pub. No.: US 2014/0084643 A1
(43) Pub. Date: Mar. 27, 2014

(54) GRIP PORTION STRUCTURE FOR FELLOW PASSENGER OF MOTORCYCLE

(71) Applicants: Shigeyuki Iwata, Kakogawa-shi (JP); Toshiyuki Nishihara, Kakogawa-shi (JP)

(72) Inventors: Shigeyuki Iwata, Kakogawa-shi (JP); Toshiyuki Nishihara, Kakogawa-shi (JP)

(21) Appl. No.: 14/116,193

(22) PCT Filed: Apr. 17, 2012
(86) PCT No.: PCT/JP2012/060320

§ 371 Date: Nov. 7, 2013

(30) Foreign Application Priority Data
May 9, 2011 (JP) P2011-104431

(51) Int. Cl. B62J 1/28; B62J 23/00

(52) U.S. Cl. CPC B62J 1/28; B62J 23/00
USPC 297/195.12

(57) ABSTRACT

There is provided a simplified grip portion structure for fellow passenger of a motorcycle, the grip portion structure having improved aesthetic appearance with no protrusion from a vehicle body. The grip portion structure for fellow passenger of a motorcycle (1) has a motorcycle seat including a front seat portion (12) on which a driver sits and a rear seat portion (13) on which a fellow passenger sits at the front and rear of the motorcycle, and a recessed portion (150) that is disposed between the front seat portion (12) and the rear seat portion (13) and is recessed toward the inside of a vehicle body, and a grip portion for the fellow passenger is disposed in the recessed portion (150).

### TECHNICAL FIELD

The present invention relates to a grip portion structure for fellow passenger of a motorcycle.

### BACKGROUND ART

Conventionally, in a motorcycle, as shown in FIG. 18, a fellow passenger sits on a fellow passenger seat 92 arranged in the rear of a driver seat 91, and grips a belt 93 attached to the fellow passenger seat 92. In this case, it is hard to insert the fellow passenger's finger between the belt 93 and the fellow passenger seat 92, and at sudden start of the motorcycle, the belt 93 can stretch.

Patent Document 1 discloses the configuration in which a fellow passenger grip handle is provided on a section of a side surface of a seat cowling, which is located between the driver seat and the fellow passenger seat.

### PRIOR ART DOCUMENTS

### Patent Documents

Patent Document 1: Japanese Unexamined Patent Publication No. 8-324472

### SUMMARY OF THE INVENTION

### Problems to be Solved by the Invention

The fellow passenger grip handle as disclosed in Patent Document 1 protrudes sideways from a vehicle body, possibly obstructing loading/unloading of the fellow passenger and driving. Further, such protrusion from the vehicle body, impairing the aesthetic appearance. Thus, an object of the present invention is to provide a simplified grip portion structure for fellow passenger of a motorcycle, the grip portion structure having improved aesthetic appearance with no protrusion from a vehicle body.

### Solutions to the Problems

A grip portion structure for fellow passenger of a motorcycle of the present invention includes a motorcycle seat including a front seat portion on which a driver sits and a rear seat portion on which a fellow passenger sits at the front and rear of the motorcycle, respectively; and a recessed portion disposed between the front seat portion and the rear seat portion, the recessed portion being recessed toward the inside of a vehicle body, wherein a grip portion for the fellow passenger is disposed in the recessed portion.

With the above-mentioned configuration, the fellow passenger grip portion structure can be simplified, and the aesthetic appearance of the structure can be improved without protruding the grip portion structure for fellow passenger from the vehicle body.

The present invention preferably has the following configurations.

(1) The two recessed portions are aligned in the vehicle width direction.

(2) The front seat portion and the rear seat portion are separated from each other in the front-back direction, and the rear seat portion is located above the front seat portion.

(3) The front seat portion and the rear seat portion are attached to a rear frame of the motorcycle, and the recessed portion is formed in a rear cowl that covers the rear frame.

(4) The recessed portion forms the grip portion.

(5) According to the configuration (4), the front seat portion and the rear seat portion are attached to a rear frame of the motorcycle, and the recessed portion is formed of a first bracket supported by the rear frame.

(6) A front end of the rear seat portion forms the grip portion.

(7) According to the configuration (6), the grip portion is formed of a bottom plate of the rear seat portion.

(8) According to the configuration (6), the grip portion is formed of a second bracket formed at a front end of the bottom plate of the rear seat portion.

(9) According to the configuration (8), the second bracket is a cylindrical member.

(10) According to the configuration (8), the second bracket is a plate member having a curved portion curved downward at a front end of the plate member.

With the configuration (1), since the two recessed portions are aligned in the vehicle width direction, the fellow passenger can easily grip the grip portion in the recessed portions with both hands.

With the configuration (2), since the front seat portion and the rear seat portion are separated from each other in the front-back direction, and the rear seat portion is located above the front seat portion, the recessed portion can be easily formed between the front seat portion and the rear seat portion.

With the configuration (3), since the recessed portion is formed in the rear cowl, the recessed portion can improve the design of the rear cowl.

With the configuration (4), since the recessed portion itself forms the grip portion, it is no need to provide a separate grip portion, simplifying the grip portion structure.

With the configuration (5), the first bracket that forms the recessed portion is supported by the rear frame, improving the structural strength of the first bracket.

With the configuration (6), since the front end of the rear seat portion forms the grip portion, it is no need to provide a separate grip portion, simplifying the grip portion structure.

With the configuration (7), the rear seat portion specifically forms the grip portion. With this configuration, the rear seat portion can easily form the grip portion.

With the configuration (8), the rear seat portion specifically forms the grip portion. With this configuration, the rear seat portion can easily form the grip portion.

With the configuration (9), since the grip portion is formed of the cylindrical member, the fellow passenger can easily grip the grip portion.

With the configuration (10), since the grip portion is formed of the plate member having the curved portion, the fellow passenger can easily grip the grip portion.

### Effects of the Invention

In summary, the present invention can provide a simplified grip portion structure for fellow passenger of a motorcycle, the grip portion structure having improved aesthetic appearance with no protrusion from the vehicle body.

### BRIEF DESCRIPTION OF THE DRAWINGS

FIG. 1 is a right side view of a motorcycle in accordance with a first embodiment of the present invention.

FIG. 2 is a top view of FIG. 1.

FIG. 3 is a perspective view of a fellow passenger seat 13 of a motorcycle 1 in FIG. 1.

FIG. 4 is a view showing the state where the fellow passenger seat 13 in FIG. 3 is removed.

FIG. 5 is a sectional view taken along a line V-V in FIG. 2.

FIG. 6 is an enlarged sectional view of the fellow passenger seat 13.

FIG. 7 is an exploded view of the fellow passenger seat 13 in FIG. 6.

FIG. 8 is a sectional view showing a structure for supporting the fellow passenger seat 13 by rear frames 14

FIG. 9 is an enlarged sectional view of the fellow passenger seat 13 in a modification example 1 of the first embodiment.

FIG. 10 is an exploded view of the fellow passenger seat 13 in FIG. 9.

FIG. 11 is an enlarged sectional view of the fellow passenger seat 13 in a modification example 2 of the first embodiment.

FIG. 12 is an exploded view of the fellow passenger seat 13 in FIG. 11

FIG. 13 is a perspective view of a grip portion structure for fellow passenger in accordance with a second embodiment of the present invention.

FIG. 14 is a sectional view taken along a line XIV-XIV in the state where the fellow passenger seat 13 is attached in FIG. 13.

FIG. 15 is a perspective view in the state where a first bracket 152 is removed in FIG. 13.

FIG. 16 is a perspective view of a grip portion structure for fellow passenger in a modification example of the second embodiment.

FIG. 17 is a sectional view taken along a line XVII-XVII in the state where the fellow passenger seat 13 and a first bracket 154 are attached in FIG. 16.

FIG. 18 is a perspective view showing of a conventional grip portion structure for fellow passenger in a rear part of the motorcycle.

### EMBODIMENTS OF THE INVENTION

### First Embodiment

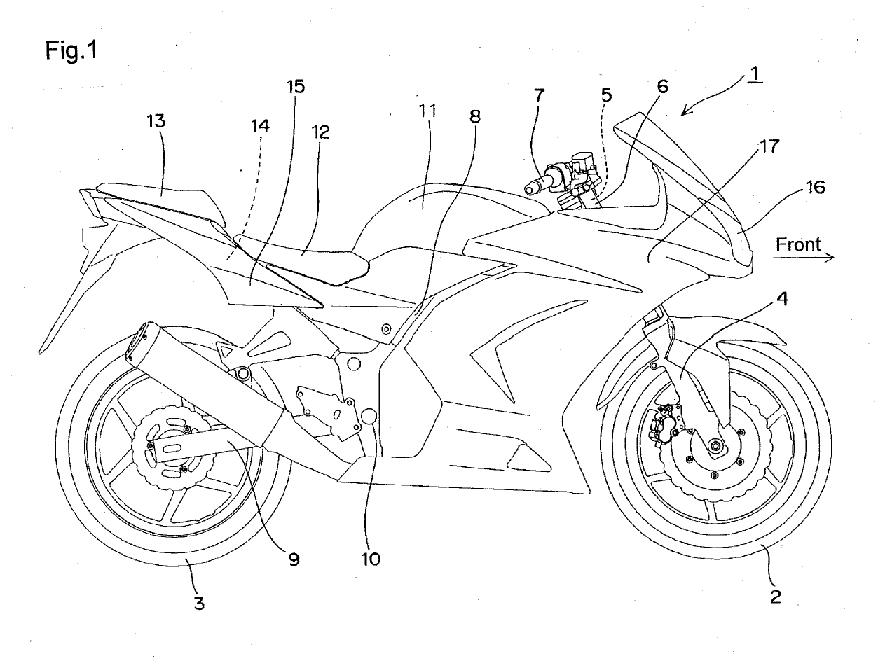

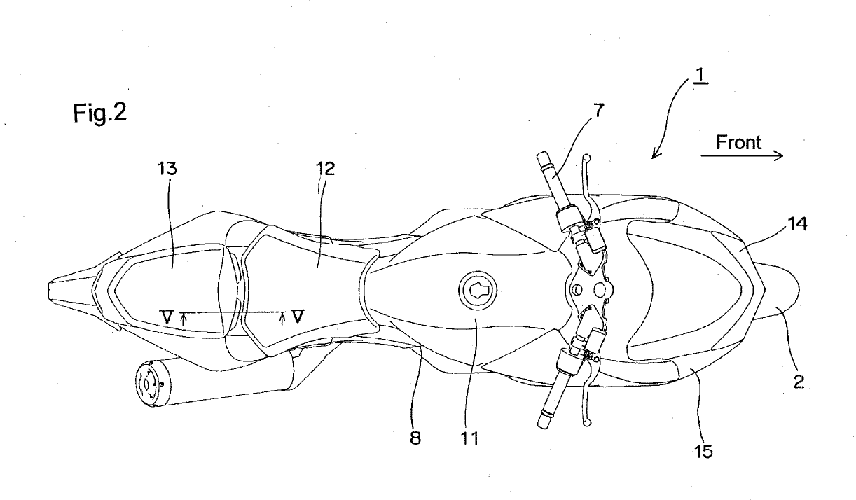

FIG. 1 is a right side view of a motorcycle in accordance with a first embodiment of the present invention, and FIG. 2 is a top view of FIG. 1. The direction used in this embodiment corresponds to the direction when viewed from the driver of the motorcycle.

As shown in FIG. 1 and FIG. 2, a motorcycle 1 includes a front wheel 2 and a rear wheel 3, and the front wheel 2 is rotatably supported by a lower part of a front fork 4 extending in the substantially vertical direction. The front fork 4 is supported by a steering shaft 5. The steering shaft 5 is rotatably supported by a head pipe 6. A bar-type horizontally extending steering handle 7 is attached to an upper bracket (not shown) provided at an upper end of the front fork 4. Accordingly, the driver horizontally rotates the steering handle 7, thereby navigating the front wheel 2 using the steering shaft 5 as the rotary axis.

A pair of right and left main frames 8 extend rearward from the head pipe 6. A front end of a swing arm 9 is pivotally supported at a lower rear end of each main frame 8 by a pivot bolt 10, and the rear wheel 3 is rotatably supported at a rear end of the swing arm 9. A fuel tank 11 is disposed above the main frames 8 and in the rear of the steering handle 7, and a driver seat 12 is disposed in the rear of the fuel tank 11. A fellow passenger seat 13 is disposed in the rear of the driver seat 12. A pair of right and left rear frames 14 are coupled to respective rear ends of the pair of right and left main frame 8, and the rear frames 14 are covered with a rear cowl 15.

A head lamp 16 is disposed in front of the steering handle 7, and the head lamp 16 is covered with a front cowl 17. An upper part of the front cowl 17 covers the head lamp 16, and a lower part of the front cowl 17 covers right and left sides such as an engine (not shown), which constitute a full cowl.

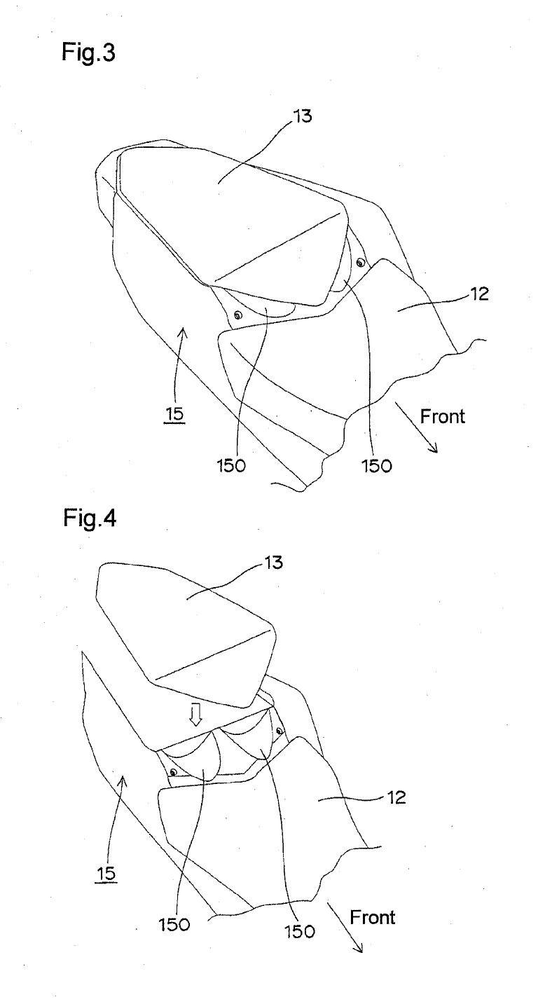

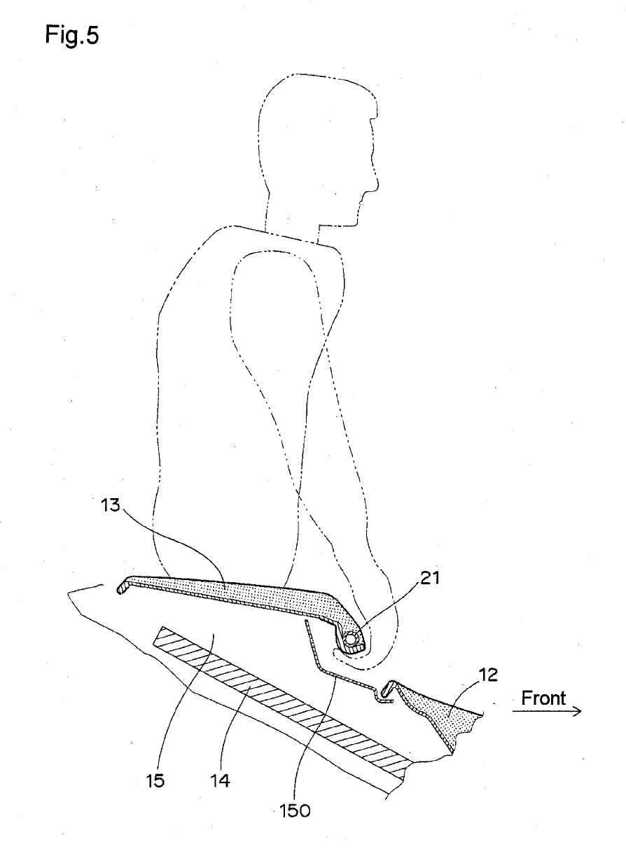

FIG. 3 is a perspective view of the fellow passenger seat 13 of the motorcycle 1 in FIG. 1, and FIG. 4 is a view showing the state where the fellow passenger seat 13 is removed in FIG. 3. FIG. 5 is a sectional view taken along a line V-V in FIG. 2. As shown in FIG. 3 to FIG. 5, the fellow passenger seat 13 is separated from the driver seat 12 located in front of the fellow passenger seat 13, and the fellow passenger seat 13 is located above the driver seat 12. Two recessed portions 150 recessed toward the inside of the vehicle body, that is, toward the lower rear side are formed in the rear cowl 15 between the driver seat 12 and the fellow passenger seat 13 so as to align in the vehicle width direction. As shown in FIG. 5, the recessed portions 150 are formed in the rear cowl 15 such that the fellow passenger can grip the front end of the fellow passenger seat 13.

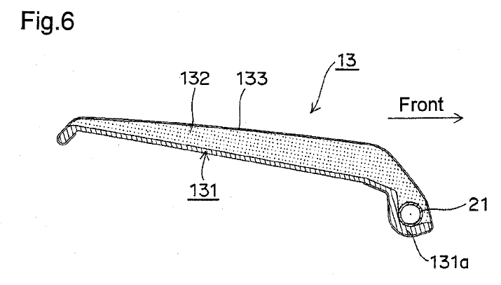

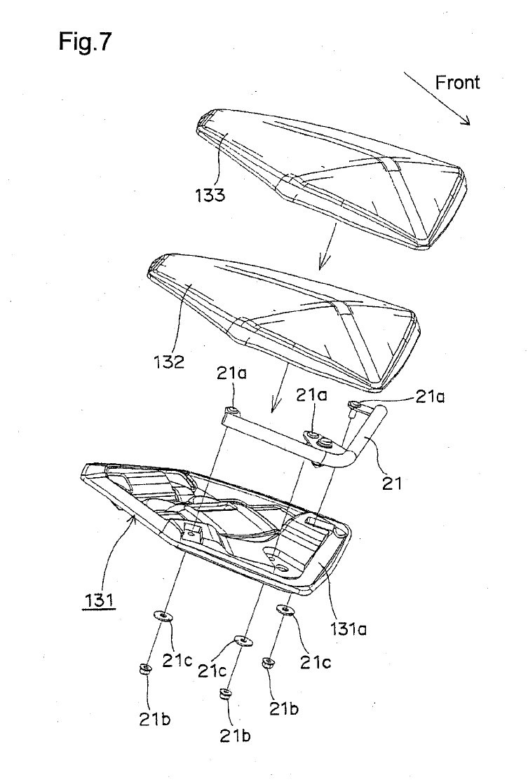

FIG. 6 is an enlarged sectional view of the fellow passenger seat 13, and FIG. 7 is an exploded view of the fellow passenger seat 13 in FIG. 6. The fellow passenger seat 13 has a bottom plate 131, a cushion 132, and a skin portion 133 from the bottom in this order. The bottom plate 131 is made of metal such as aluminum, the cushion 132 is made of urethane or the like, and the skin portion 133 is made of skin or the like. The fellow passenger sits on an upper surface of the skin portion 133. A curved portion 131a curved downward is formed at the front end of the bottom plate 131, and a reinforcing bracket 21 is attached to the upper surface of the curved portion 131a with a bolt 21a, a nut 21b, and a washer 21c. The reinforcing bracket 21 has a C-like cylindrical member, a central part of which in the vehicle width direction protrudes forward. The fellow passenger grips the curved portion 131a formed at the front end of the fellow passenger seat 13.

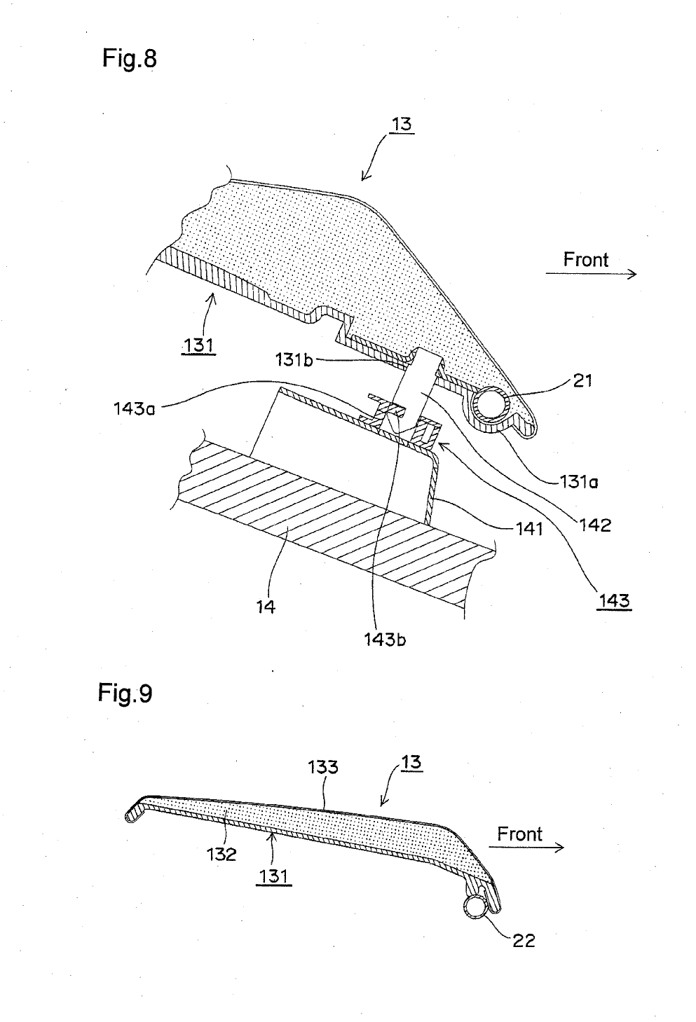

FIG. 8 is a sectional view showing a structure for supporting the fellow passenger seat 13 by the rear frames 14. A supporting bracket 141 is attached to the upper surface of the rear frame 14, and a lock table 143 is fixedly attached to the supporting bracket 141. A bolt insertion portion 143a, into which a lower end of a coupling bolt 142 is inserted, is formed in the lock table 143. A bolt fixing hole 131b is formed in the bottom plate 131 of the fellow passenger seat 13 in the rear of the curved portion 131a, and an upper end of the coupling bolt 142 is inserted into and welded with the bolt fixing hole 131b. Then, the lower end of the coupling bolt 142 is inserted into the bolt insertion portion 143a, and a lock piece 143b locks a lock groove of the coupling bolt 142, so that the fellow passenger seat 13 is fixedly supported by the rear frames 14.

The grip portion structure for fellow passenger with the above-mentioned configuration has following effects.

(1) Since the grip portion for the fellow passenger is disposed in the recessed portions 150 formed in the rear cowl 15, the fellow passenger grip portion structure can be simplified, and the grip portion structure for fellow passenger can be prevented from protruding outwards from the vehicle body in the vehicle width direction. As a result, the grip portion for the fellow passenger does not obstruct loading/unloading to/from the motorcycle and driving of the motorcycle, and the aesthetic appearance of the motorcycle can be improved.

(2) Since the two recessed portions 150 are aligned in the vehicle width direction, the fellow passenger can easily grip the grip portion in the recessed portions 150 with both hands.

(3) Since the driver seat 12 and the fellow passenger seat 13 are separated from each other in the front-back direction and the fellow passenger seat 13 is located above the driver seat 12, the recessed portions 150 can be easily formed between the driver seat 12 and the fellow passenger seat 13.

(4) The recessed portions 150 are formed in the rear cowl 15 and thus, can improve the design of the rear cowl 15.

(5) Since the curved portion 131a as the front end of the bottom plate 131 of the fellow passenger seat 13 forms the grip portion, it is no need to provide a separate grip portion, simplifying the grip portion structure.

(6) Since the reinforcing bracket 21 is attached to the curved portion 131a, the structural strength of the curved portion 131a as the grip portion can be increased.

### Modification Example 1 of First Embodiment

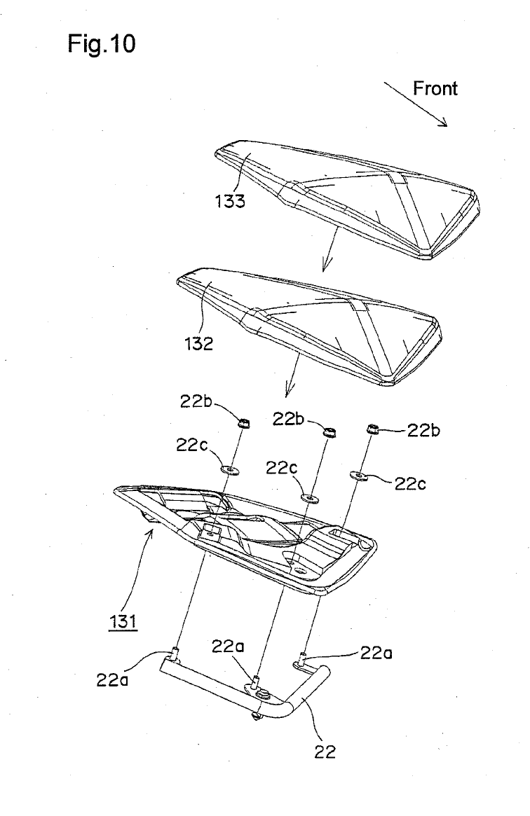

FIG. 9 is an enlarged sectional view of the fellow passenger seat 13 in a modification example 1 of the first embodiment, and FIG. 10 is an exploded view of the fellow passenger seat 13 in FIG. 9. This embodiment and the first embodiment are different from each other in the configuration of the fellow passenger seat 13, and are the same as each other in the other configuration. Thus, in this embodiment, only the configuration of the fellow passenger seat 13 will be described.

The fellow passenger seat 13 has a bottom plate 131, a cushion 132, and a skin portion 133 from the bottom in this order. The bottom plate 131 is made of metal such as aluminum, the cushion 132 is made of urethane or the like, and the skin portion 133 is made of skin or the like. The fellow passenger sits on an upper surface of the skin portion 133. A second bracket 22 is attached to a lower surface of a front end of the bottom plate 131 with a bolt 22a, a nut 22b, and a washer 22c. The second bracket 22 has a C-like cylindrical member, a central part of which in the vehicle width direction protrudes forward.

The grip portion structure for fellow passenger with the above-mentioned configuration has following effects.

(1) Since the grip portion is formed of the cylindrical member, the fellow passenger can easily grip the grip portion.

(2) The second bracket 22 is attached to the front end of the bottom plate 131 of the fellow passenger seat 13, increasing the structural strength of the front end.

### Modification Example 2 of First Embodiment

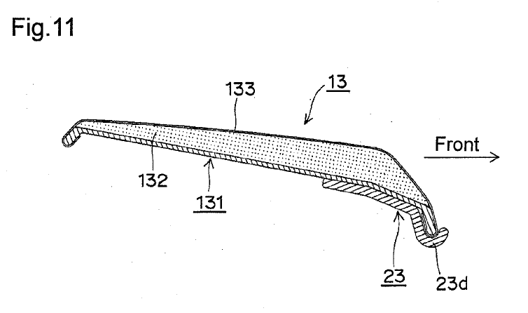

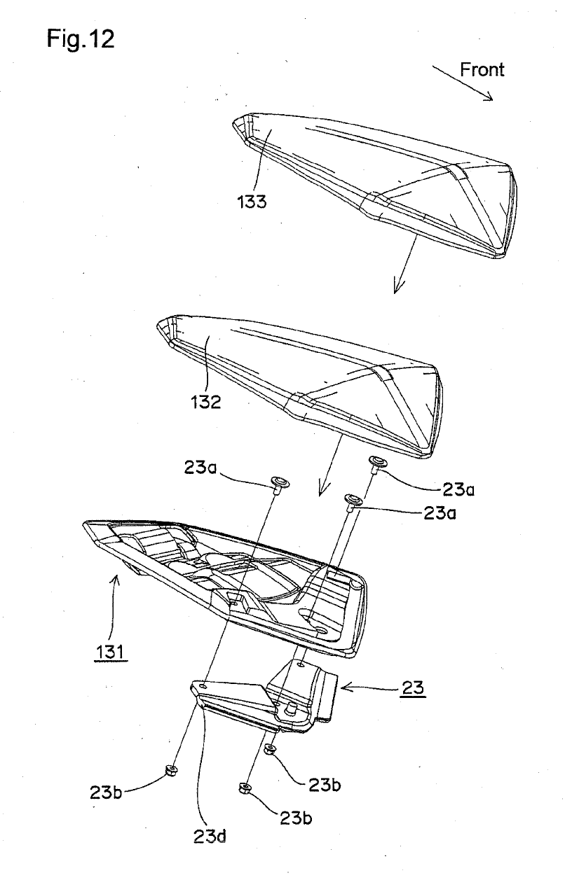

FIG. 11 is an enlarged sectional view of the fellow passenger seat 13 in a modification example 2 of the first embodiment, and FIG. 12 is an exploded view of the fellow passenger seat 13 in FIG. 11. This embodiment and the first embodiment are different from each other in the configuration of the fellow passenger seat 13, and are the same as each other in the other configuration. Thus, in this embodiment, only the configuration of the fellow passenger seat 13 will be described.

The fellow passenger seat 13 has a bottom plate 131, a cushion 132, and a skin portion 133 from the bottom in this order. The bottom plate 131 is made of metal such as aluminum, the cushion 132 is made of urethane or the like, and the skin portion 133 is made of skin or the like. The fellow passenger sits on an upper surface of the skin portion 133. A second bracket 23 is attached to a lower surface of a front portion of the bottom plate 131 with a bolt 23a and a nut 23b. The second bracket 23 is a C-like plate member, a central portion of which in the vehicle width direction protrudes forward, and has a curved portion 23d curved downward at its front end.

The grip portion structure for fellow passenger with the above-mentioned configuration has following effects.

(1) Since the second bracket 23 as the grip portion has the curved portion 23d curved downward at its front end, the fellow passenger can easily grip the second bracket 23.

(2) Since the second bracket 23 is attached to the front portion of the bottom plate 131 of the fellow passenger seat 13, the structural strength of the front portion can be increased.

### Second Embodiment

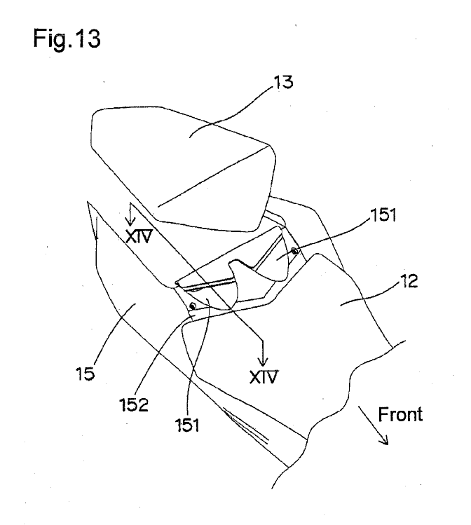

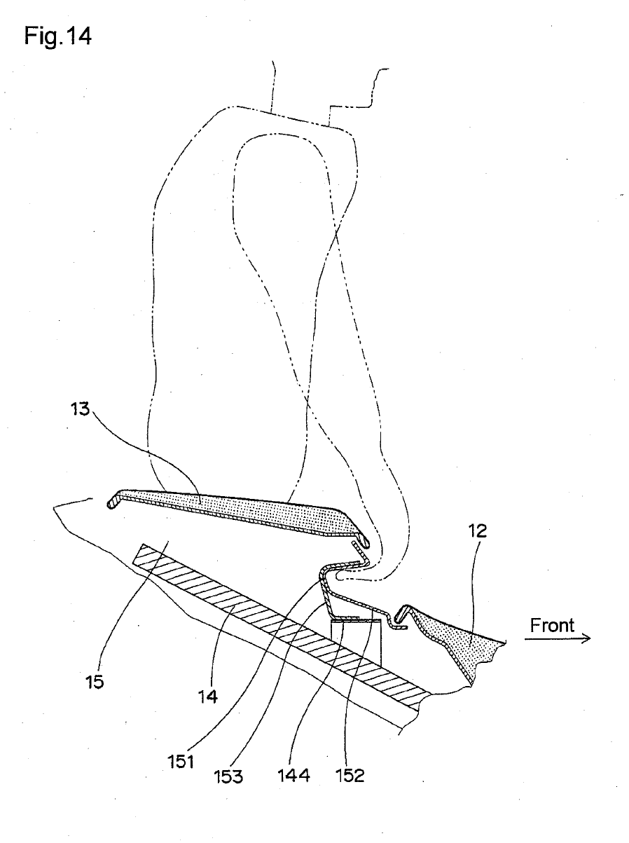

FIG. 13 is a perspective view of a grip portion structure for fellow passenger in accordance with a second embodiment of the present invention. FIG. 13 shows the state where the fellow passenger seat 13 is removed. FIG. 14 is a sectional view taken along a line XIV-XIV in the state where the fellow passenger seat 13 is attached in FIG. 13. This embodiment and the first embodiment are different from each other in that the recessed portion rather than the front end of the fellow passenger seat 13 forms the grip portion, and are the same as each other in the other configuration. Thus, the same parts and portions in this embodiment as those in the first embodiment are given the same reference numerals and thus, detailed description thereof is omitted.

As shown in FIG. 13 and FIG. 14, the fellow passenger seat 13 is separated from the driver seat 12 located in front of the fellow passenger seat 13, and is located above the driver seat 12. Two recessed portions 151 recessed toward the inside of the vehicle body, that is, toward the lower rear side, are formed in a first bracket 152 between the driver seat 12 and the fellow passenger seat 13 so as to align in the vehicle width direction. Then, as shown in FIG. 14, the fellow passenger grip the recessed portions 151 of the first bracket 152.

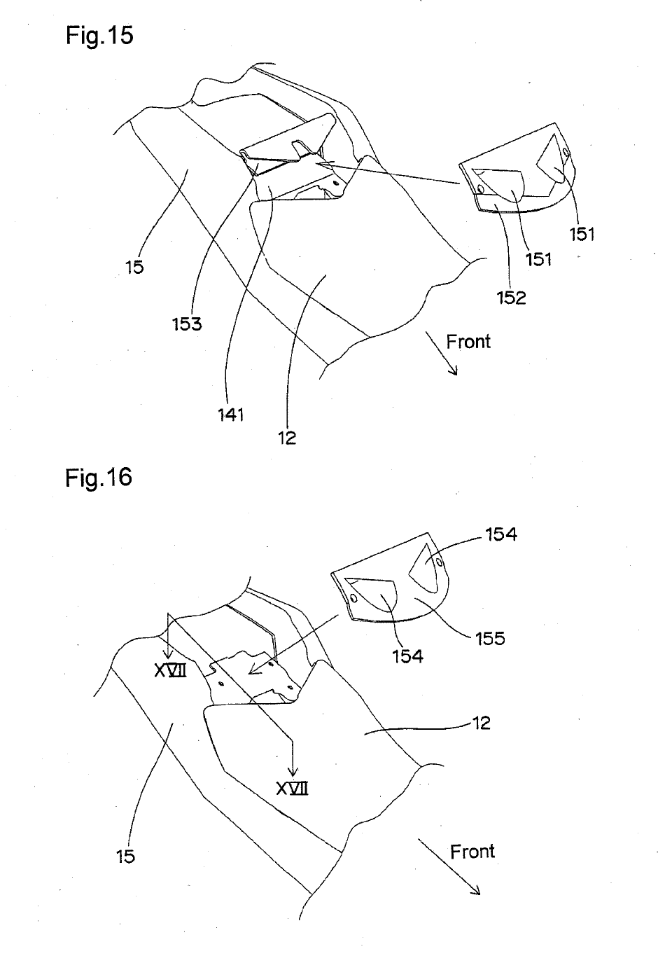

As shown in FIG. 14, a supporting bracket 144 is attached to the rear frame 14, and a reinforcing bracket 153 for supporting a part of a rear surface of the first bracket 152 is attached to an upper surface of the supporting bracket 144. FIG. 15 is a perspective view in the state where the first bracket 152 is removed in FIG. 13. The reinforcing bracket 153 has a C-like shape having an opening at its front so as to correspond to the recessed portion 151 of the first bracket 152.

The grip portion structure for fellow passenger with the above-mentioned configuration has following effects.

Since the recessed portions 151 themselves of the first bracket 152 form the grip portion, it is no need to provide a separate grip portion, simplifying the grip portion structure.

The first bracket 152 forming the recessed portion 151 is supported by the rear frames 14 via the reinforcing bracket 153 and the supporting bracket 144, increasing the structural strength of the first bracket 152. The first bracket 152 may be supported directly by the rear frame without the reinforcing bracket 153 and the supporting bracket 144.

### Modification Example of Second Embodiment

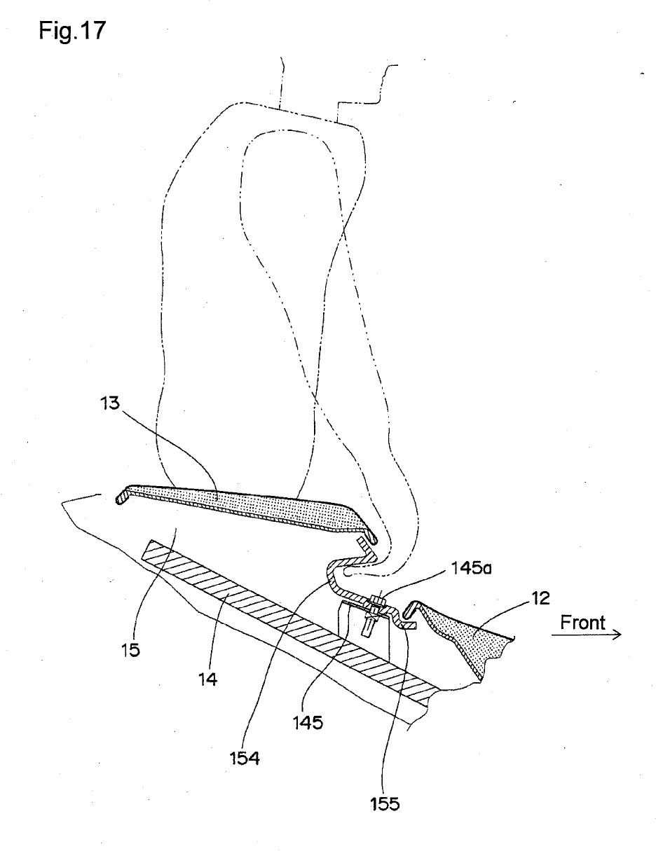

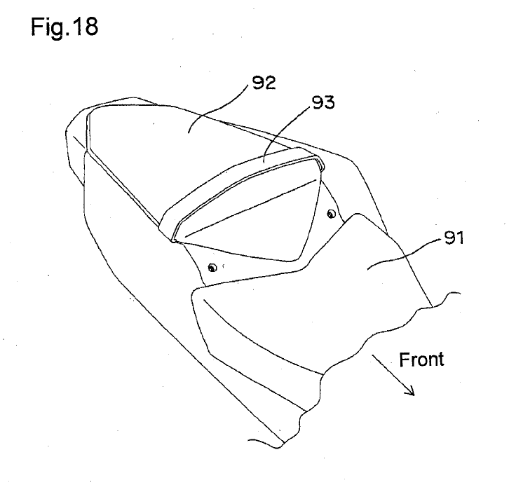

FIG. 16 is a perspective view of a grip portion structure for fellow passenger in a modification example of the second embodiment. FIG. 16 shows the state where the fellow passenger seat 13 and a first bracket 155 are removed. FIG. 17 is a sectional view taken along a line XVII-XVII in the state where the fellow passenger seat 13 and the first bracket 155 are attached in FIG. 16. This embodiment and the second embodiment are different from each other in the configuration of the first bracket and the configuration for supporting the first bracket by the rear frames 14, and are the same as each other in the other configuration. Thus, in this embodiment, only the above-mentioned differences will be described.

As shown in FIG. 16 and FIG. 17, the fellow passenger seat 13 is separated from the driver seat 12 located in front of the fellow passenger seat 13, and is located above the driver seat 12. Two recessed portions 154 recessed toward the inside of the vehicle body, that is, toward the lower rear side, are formed in a first bracket 155 between the driver seat 12 and the fellow passenger seat 13 so as to align in the vehicle width direction. Then, as shown in FIG. 17, the fellow passenger grip the recessed portions 154 of the first bracket 155.

As shown in FIG. 17, a supporting bracket 145 is attached to the upper surface of the rear frame 14. The first bracket 155 is attached to the upper surface of the supporting bracket 145 with an attachment bolt 145a. As a result, the first bracket 155 is supported by the rear frames 14.

The grip portion structure for fellow passenger with the above-mentioned configuration has following effects.

Since the first bracket 155 is attached to the supporting bracket 145, the reinforcing bracket 153 in the second embodiment can be omitted, simplifying the grip portion structure. In this case, to ensure the structural strength of the first bracket 155, the first bracket 155 is set to be thicker than the first bracket 152 in the second embodiment.

The first bracket 155 forming the recessed portion 154 is supported by the rear frames 14 via the supporting bracket 145, increasing the structural strength of the first bracket 155. The first bracket 155 may be directly supported by the rear frames 14 without through the supporting bracket 145.

### Other Embodiments

In the above-mentioned embodiments, the recessed portion formed in the front end of the fellow passenger seat 13 or the rear cowl 15 constitutes the fellow passenger grip portion and however, in spite of the sheet 13 and the recessed portion, a member having the grip portion structure for fellow passenger may be disposed in the recessed portion.

In the above-mentioned embodiments, the two recessed portions are formed in the vehicle width direction such that the fellow passenger can grip the grip portion with his/her both hands and however, only one recessed portion extending in the vehicle width direction may be formed. In the above-mentioned embodiments, the recessed portion is formed toward the lower rear side and however, may be recessed in the other directions as long as it is recessed toward the inside of the vehicle body. The shape and number of the recessed portion are not limited to the above-mentioned shape and number, and may be selected in consideration of design.

In the above-mentioned embodiments, the driver seat 12 is separated from the fellow passenger seat 13 in the front-back direction and however, the driver seat and the fellow passenger seat may be integrated with each other, and a recessed portion may be formed between the front seat portion on which the driver sits and the rear seat portion on which the fellow passenger sits.

In the above-mentioned embodiments, the recessed portion is formed in the rear cowl and the first bracket attached to the rear frame and however, the recessed portion may be formed in a sheet or other constituents.

Various modifications and changes can be made without departing from the sprit and scope of the present invention, which are described in CLAIMS.

### INDUSTRIAL APPLICABILITY

The grip portion structure for fellow passenger according to the present invention can be simplified and can improve its aesthetic appearance with no protrusion from the vehicle body, which is industrially useful.

### DESCRIPTION OF REFERENCE SIGNS

1: motorcycle
2: front wheel
3: rear wheel
4: front fork
5: steering shaft
6: head pipe
7: steering handle
8: main frame
9: swing arm
10: pivot bolt
11: fuel tank
12: driver seat
13: fellow passenger seat
131: bottom plate
131a: curved portion
131b: bolt fixing hole
132: cushion
133: skin portion
14: rear frame
141: supporting bracket
142: coupling bolt
143: lock table
143a: bolt insertion portion
143b: lock piece
144: supporting bracket
145: supporting bracket
145a: attachment bolt
15: rear cowl
150: recessed portion
151: recessed portion
152: first bracket
153: reinforcing bracket
154: recessed portion
155: first bracket
16: head lamp
17: front cowl
21: reinforcing bracket
21a: bolt
21b: nut
21c: washer
22: second bracket
22a: bolt
22b: nut
22c: washer
23: second bracket
23a: bolt
23b: nut
91: driver seat
92: fellow passenger seat
93: belt

1. A grip portion structure for fellow passenger of a motorcycle, the grip portion structure comprising:
a motorcycle seat including a front seat portion on which a driver sits and a rear seat portion on which a fellow passenger sits at the front and rear of the motorcycle, respectively; and
a recessed portion disposed between the front seat portion and the rear seat portion, the recessed portion being recessed toward the inside of a vehicle body, wherein
a grip portion for the fellow passenger is disposed in the recessed portion.

2. The grip portion structure for fellow passenger according to claim 1, wherein
the two recessed portions are aligned in the vehicle width direction.

3. The grip portion structure for fellow passenger according to claim 1, wherein
the front seat portion and the rear seat portion are separated from each other in the front-back direction, and
the rear seat portion is located above the front seat portion.

4. The grip portion structure for fellow passenger according to claim 1, wherein
the front seat portion and the rear seat portion are attached to a rear frame of the motorcycle, and
the recessed portion is formed in a rear cowl that covers the rear frame.

5. The grip portion structure for fellow passenger according to claim 1, wherein the recessed portion forms the grip portion.

6. The grip portion structure for fellow passenger according to claim 5, wherein
the front seat portion and the rear seat portion are attached to a rear frame of the motorcycle, and
the recessed portion is formed of a first bracket supported by the rear frame.

7. The grip portion structure for fellow passenger according to claim 1, wherein a front end of the rear seat portion forms the grip portion.

8. The grip portion structure for fellow passenger according to claim 7, wherein the grip portion is formed of a bottom plate of the rear seat portion.

9. The grip portion structure for fellow passenger according to claim 7, wherein the grip portion is formed of a second bracket formed at a front end of the bottom plate of the rear seat portion.

10. The grip portion structure for fellow passenger according to claim 9, wherein the second bracket is a cylindrical member.

11. The grip portion structure for fellow passenger according to claim 9, wherein the second bracket is a plate member having a curved portion curved downward at a front end of the plate member.
